(19) United States
(12) Patent Application Publication
(10) Pub. No.: US 2012/0066137 A1
(43) Pub. Date: Mar. 15, 2012

(54) SYSTEM FOR AND METHODS OF CONFIRMING LOCATE OPERATION WORK ORDERS WITH RESPECT TO MUNICIPAL PERMITS

(75) Inventors: Steven Nielsen, North Palm Beach, FL (US); Curtis Chambers, Palm Beach Gardens, FL (US); Jeffrey Farr, Jupiter, FL (US)

(73) Assignee: CertusView Technolgies, LLC

(21) Appl. No.: 13/186,116

(22) Filed: Jul. 19, 2011

Related U.S. Application Data
(60) Provisional application No. 61/369,092, filed on Jul. 30, 2010.

(51) Int. Cl. G06Q 10/00

(52) U.S. Cl. 705/317

(57) ABSTRACT

Determining a permit status of a jobsite at which a locate operation is requested and/or performed. A work order that describes the locate operation is received and processed, and a permit database of a permitting entity is accessed based at least in part on information from the work order. The permit database is electronically reviewed to determine whether a valid permit covers work at the jobsite.

### CROSS-REFERENCES TO RELATED APPLICATIONS

This application claims the benefit, under 35 U.S.C. §119(e), of U.S. Provisional Patent Application No. 61/369,092, filed on Jul. 30, 2010 under Atty. Docket No. 098689-0247 (DYC0078US00) entitled “System for and Methods of Confirming Locate Operation Work Orders with Respect to Municipal Permits,” which application is hereby incorporated herein by reference.

### BACKGROUND

Field service operations may be any operation in which companies dispatch technicians and/or other staff to perform certain activities, for example, installations, services and/or repairs. Field service operations may exist in various industries, examples of which include, but are not limited to, network installations, utility installations, security systems, construction, medical equipment, heating, ventilating and air conditioning (HVAC) and the like.

An example of a field service operation in the construction industry is a so-called “locate and marking operation,” also commonly referred to more simply as a “locate operation” (or sometimes merely as “a locate”). In a typical locate operation, a locate technician visits a work site in which there is a plan to disturb the ground (e.g., excavate, dig one or more holes and/or trenches, bore, etc.) so as to determine a presence or an absence of one or more underground facilities (such as various types of utility cables and pipes) in a dig area to be excavated or disturbed at the work site. In some instances, a locate operation may be requested for a “design” project, in which there may be no immediate plan to excavate or otherwise disturb the ground, but nonetheless information about a presence or absence of one or more underground facilities at a work site may be valuable to inform a planning, permitting and/or engineering design phase of a future construction project.

In many states, an excavator who plans to disturb ground at a work site is required by law to notify any potentially affected underground facility owners prior to undertaking an excavation activity. Advanced notice of excavation activities may be provided by an excavator (or another party) by contacting a “one-call center.” One-call centers typically are operated by a consortium of underground facility owners for the purposes of receiving excavation notices and in turn notifying facility owners and/or their agents of a plan to excavate. As part of an advanced notification, excavators typically provide to the one-call center various information relating to the planned activity, including a location (e.g., address) of the work site and a description of the dig area to be excavated or otherwise disturbed at the work site.

A locate operation is initiated as a result of an excavator providing an excavation notice to a one-call center. An excavation notice also is commonly referred to as a “locate request,” and may be provided by the excavator to the one-call center via an electronic mail message, information entry via a website maintained by the one-call center, or a telephone conversation between the excavator and a human operator at the one-call center. The locate request may include an address or some other location-related information describing the geographic location of a work site at which the excavation is to be performed, as well as a description of the dig area (e.g., a text description), such as its location relative to certain landmarks and/or its approximate dimensions, within which there is a plan to disturb the ground at the work site. One-call centers similarly may receive locate requests for design projects (for which, as discussed above, there may be no immediate plan to excavate or otherwise disturb the ground).

Once facilities implicated by the locate request are identified by a one-call center, the one-call center generates a “locate request ticket” (also known as a “locate ticket,” or simply a “ticket”). The locate request ticket essentially constitutes an instruction to inspect a work site and typically identifies the work site of the proposed excavation or design and a description of the dig area, typically lists on the ticket all of the underground facilities that may be present at the work site (e.g., by providing a member code for the facility owner of an underground facility), and may also include various other information relevant to the proposed excavation or design (e.g., the name of the excavation company, a name of a property owner or party contracting the excavation company to perform the excavation, etc.). The one-call center sends the ticket to one or more underground facility owners and/or one or more locate service providers (who may be acting as contracted agents of the facility owners) so that they can conduct a locate and marking operation to verify a presence or absence of the underground facilities in the dig area. For example, in some instances, a given underground facility owner may operate its own fleet of locate technicians, in which case the one-call center may send the ticket to the underground facility owner. In other instances, a given facility owner may contract with a locate service provider to receive locate request tickets and perform a locate and marking operation in response to received tickets on their behalf

Upon receiving the locate request, a locate service provider or a facility owner (hereafter referred to as a “ticket recipient”) may dispatch a locate technician to the work site of planned excavation to determine a presence or absence of one or more underground facilities in the dig area to be excavated or otherwise disturbed. A typical first step for the locate technician includes utilizing an underground facility “locate device,” which is an instrument or set of instruments (also referred to commonly as a “locate set”) for detecting facilities that are concealed in some manner, such as cables and pipes that are located underground. The locate device is employed by the technician to verify the presence or absence of underground facilities indicated in the locate request ticket as potentially present in the dig area (e.g., via the facility owner member codes listed in the ticket). This process is often referred to as a “locate operation.”

In one example of a locate operation, an underground facility locate device is used to detect electromagnetic fields that are generated by an applied signal provided along a length of a target facility to be identified. In this example, a locate device may include both a signal transmitter to provide the applied signal (e.g., which is coupled by the locate technician to a tracer wire disposed along a length of a facility), and a signal receiver which is generally a hand-held apparatus carried by the locate technician as the technician walks around the dig area to search for underground facilities. The transmitter is connected, via a connection point, to a target object located in the ground. The transmitter generates the applied signal, which is coupled to the underground facility via the connection point (e.g., to a tracer wire along the facility), resulting in the generation of a magnetic field. The magnetic field in turn is detected by the locate receiver, which itself may include at least one detection antenna. The locate receiver indicates a presence of a facility when it detects electromagnetic fields arising from the applied signal. Conversely, the absence of a signal detected by the locate receiver generally indicates the absence of the target facility.

In yet another example, a locate device employed for a locate operation may include a single instrument, similar in some respects to a conventional metal detector. In particular, such an instrument may include an oscillator to generate an alternating current that passes through a coil, which in turn produces a first magnetic field. If a piece of electrically conductive metal is in close proximity to the coil (e.g., if an underground facility having a metal component is below/near the coil of the instrument), eddy currents are induced in the metal and the metal produces its own magnetic field, which in turn affects the first magnetic field. The instrument may include a second coil to measure changes to the first magnetic field, thereby facilitating detection of metallic objects.

In addition to the locate operation, the locate technician also generally performs a “marking operation,” in which the technician marks the presence (and in some cases the absence) of a given underground facility in the dig area based on the various signals detected (or not detected) during the locate operation. For this purpose, the locate technician conventionally utilizes a “marking device” to dispense a marking material on, for example, the ground, pavement, or other surface along a detected underground facility. Marking material may be any material, substance, compound, and/or element, used or which may be used separately or in combination to mark, signify, and/or indicate. Examples of marking materials may include, but are not limited to, paint, chalk, dye, and/or iron. Marking devices, such as paint marking wands and/or paint marking wheels, provide a convenient method of dispensing marking materials onto surfaces, such as onto the surface of the ground or pavement.

A conventional marking device includes a mechanical actuation system to dispense paint as a marker. Generally speaking, the marking device includes a handle at a proximal end of an elongated shaft and resembles a sort of “walking stick,” such that a technician may operate the marking device while standing/walking in an upright or substantially upright position. A marking dispenser holder is coupled to a distal end of the shaft so as to contain and support a marking dispenser, e.g., an aerosol paint can having a spray nozzle. Typically, a marking dispenser in the form of an aerosol paint can is placed into the holder upside down, such that the spray nozzle is proximate to the distal end of the shaft (close to the ground, pavement or other surface on which markers are to be dispensed).

The mechanical actuation system of the marking device includes an actuator or mechanical trigger proximate to the handle that is actuated/triggered by the technician (e.g., via pulling, depressing or squeezing with fingers/hand). The actuator is connected to a mechanical coupler (e.g., a rod) disposed inside and along a length of the elongated shaft. The coupler is in turn connected to an actuation mechanism, at the distal end of the shaft, which mechanism extends outward from the shaft in the direction of the spray nozzle. Thus, the actuator, the mechanical coupler, and the actuation mechanism 58 constitute the mechanical actuation system of the marking device.

In the non-actuated state of the conventional marking device, the actuator is “at rest” (not being pulled) and, as a result, the actuation mechanism is not in contact with the spray nozzle. In the actuated state, the actuator is being actuated (pulled, depressed, squeezed) by the technician. When actuated, the actuator displaces the mechanical coupler and the actuation mechanism such that the actuation mechanism contacts and applies pressure to the spray nozzle, thus causing the spray nozzle to deflect slightly and dispense paint. The mechanical actuation system is spring-loaded so that it automatically returns to the non-actuated state when the actuator is released.

In some environments, arrows, flags, darts, or other types of physical marks may be used to mark the presence or absence of an underground facility in a dig area, in addition to or as an alternative to a material applied to the ground (such as paint, chalk, dye, tape) along the path of a detected utility. The marks resulting from any of a wide variety of materials and/or objects used to indicate a presence or absence of underground facilities generally are referred to as “locate marks.” Often, different color materials and/or physical objects may be used for locate marks, wherein different colors correspond to different utility types. For example, the American Public Works Association (APWA) has established a standardized color-coding system for utility identification for use by public agencies, utilities, contractors and various groups involved in ground excavation (e.g., red=electric power lines and cables; blue=potable water; orange=telecommunication lines; yellow=gas, oil, steam). In some cases, the technician also may provide one or more marks to indicate that no facility was found in the dig area (sometimes referred to as a “clear”).

As mentioned above, the foregoing activity of identifying and marking a presence or absence of one or more underground facilities generally is referred to for completeness as a “locate and marking operation.” However, in light of common parlance adopted in the construction industry, and/or for the sake of brevity, one or both of the respective locate and marking functions may be referred to in some instances simply as a “locate operation” or a “locate” (i.e., without making any specific reference to the marking function). Accordingly, it should be appreciated that any reference in the relevant arts to the task of a locate technician simply as a “locate operation” or a “locate” does not necessarily exclude the marking portion of the overall process. At the same time, in some contexts a locate operation is identified separately from a marking operation, wherein the former relates more specifically to detection-related activities and the latter relates more specifically to marking-related activities.

Inaccurate locating and/or marking of underground facilities can result in physical damage to the facilities, property damage, and/or personal injury during the excavation process that, in turn, can expose a facility owner or contractor to significant legal liability. When underground facilities are damaged and/or when property damage or personal injury results from damaging an underground facility during an excavation, the excavator may assert that the facility was not accurately located and/or marked by a locate technician, while the locate contractor who dispatched the technician may in turn assert that the facility was indeed properly located and marked. Proving whether the underground facility was properly located and marked can be difficult after the excavation (or after some damage, e.g., a gas explosion), because in many cases the physical locate marks (e.g., the marking material or other physical marks used to mark the facility on the surface of the dig area) will have been disturbed or destroyed during the excavation process (and/or damage resulting from excavation).

### SUMMARY

Applicants have recognized and appreciated that uncertainties which may be attendant to locate and marking operations may be significantly reduced by collecting various information particularly relating to the marking operation, and in some cases both the marking operation and the corresponding locate operation, rather than merely focusing on information relating to detection of underground facilities via a locate device. In many instances, excavators arriving to a work site have only physical locate marks on which to rely to indicate a presence or absence of underground facilities, and they are not generally privy to information that may have been collected previously during the locate operation. Accordingly, the integrity and accuracy of the physical locate marks applied during a marking operation arguably is significantly more important in connection with reducing risk of damage and/or injury during excavation than the location where an underground facility was detected via a locate device during a locate operation.

More specifically, Applicants have recognized and appreciated that conventional techniques for using a locate device to detect underground facilities are sometimes tentative and typically iterative in nature, and use of locate devices with GPS capabilities may result in redundant, spurious and/or incomplete geographic location data collection. For example, during a typical locate operation, a technician attempting to locate an underground facility with a locate device often needs to sweep an appreciable area around a suspected underground facility, and make multiple passes with the locate device over the underground facility to obtain meaningful detection signals. Furthermore, the technician often needs to rely significantly on visual observations of the area, including relevant landmarks such as facility connections to buildings, transformer boxes, maintenance/public access points, curbs, sidewalks, roadways, etc., to effectively deduce a sensible path of an underground facility to be located. The foregoing is particularly true if at some point during the locate operation the technician loses a signal from an underground facility in the process of being detected (e.g., due to a broken transmitter circuit path from a damaged tracer wire, and loss of the transmitter's applied signal). In view of the foregoing, it may be readily appreciated that collecting and logging geographic location information throughout this process may result in excessive and/or imprecise data, or in some instances incomplete relevant data (e.g., in the case of signal loss/broken tracer wire), from which it may be difficult to cull the data that is truly complete and representative of where the underground facility ultimately was detected.

Yet, Applicants have recognized and appreciated that collecting location data, such as GPS data, in connection with use of a locate device may be valuable for reasons other than marking a location of an underground facility. For example, the data may be valuable in monitoring the performance of a technician (e.g., by comparing performance to a known “signature” of a technician's historical performance), mapping areas of poor signal strength, or for other reasons. The data may be processed in various manners of use to various parties, depending on their particular interest in a locate operation. In addition, as described further below, the collection of GPS data with respect to both locate and marking operations, as opposed to locate operations alone, may also provide valuable insight and analysis potential with respect to various aspects (e.g., technician performance, comparison to historical data, etc.) of a locate operation.

Furthermore, Applicants have recognized and appreciated that the location at which an underground facility ultimately is detected during a locate operation is not always where the technician physically marks the ground, pavement or other surface during a marking operation; in fact, technician imprecision or negligence, as well as various ground conditions and/or different operating conditions amongst different locate devices, may in some instances result in significant discrepancies between detected location and physical locate marks. Accordingly, having documentation (e.g., an electronic record) of where physical locate marks were actually dispensed (i.e., what an excavator encounters when arriving to a work site) is notably more relevant to the assessment of liability in the event of damage and/or injury than where an underground facility was detected prior to marking

Examples of marking devices configured to collect some types of information relating specifically to marking operations are provided in U.S. publication no. 2008-0228294-A1, published Sep. 18, 2008, filed Mar. 13, 2007, and entitled “Marking System and Method With Location and/or Time Tracking,” and U.S. publication no. 2008-0245299-A1, published Oct. 9, 2008, filed Apr. 4, 2007, and entitled “Marking System and Method,” both of which publications are incorporated herein by reference. These publications describe, amongst other things, collecting information relating to the geographic location, time, and/or characteristics (e.g., color/type) of dispensed marking material from a marking device and generating an electronic record based on this collected information. Applicants have recognized and appreciated that collecting information relating to both geographic location and color of dispensed marking material provides for automated correlation of geographic information for a locate mark to facility type (e.g., red=electric power lines and cables; blue=potable water; orange=telecommunication lines; yellow=gas, oil, steam).

In view of the foregoing, embodiments of the invention relate to systems for and methods of confirming locate operation work orders with respect to municipal permits. For example, an excavator notification system of the present invention provides mechanisms for using locate operation work order information to access a database including relevant electronic records of municipal permits in order to (1) determine the status (i.e., existence of or absence of) a municipal permit for a locate operation work order, (2) determine whether the information of the locate operation work order is in compliance with the information of its corresponding municipal permit, and/or (3) provide municipal permit status information to interested parties, such as to regulators, facility owners, the locate company, the one-call center from which the locate operation work order originated, and/or the excavator from which the locate operation work order originated.

The excavator notification system and methods of the present invention allow, for example, locate companies to confirm in advance of performing locate operations whether a valid municipal permit exists for the jobsite that is the subject of the locate operation work order. When the existence of the valid municipal permit is confirmed, this information may be transmitted to the originating parties, and locate operations and/or excavation operations may be performed. When the existence of the valid municipal permit is not confirmed, the work associated with the locate operation work order may still be performed in some embodiments. However, an alert may be transmitted to the originating parties that a valid municipal permit is not confirmed. Further, the alert status may be logged in the electronic record of the locate operation. In other embodiments, the work associated with the locate operation work order may be delayed or otherwise not performed when a valid municipal permit is not found.

According to a first aspect of the invention, a method is provided for performing a locate operation to locate the presence or absence of underground facilities at a jobsite. The method comprises receiving, by a computing device, a work order that describes a locate operation to locate the presence or absence of underground facilities at a jobsite; accessing, by the computing device, a permit database of a permitting entity based on information from the work order; and determining, by the computing device, from the permit database of the permitting entity, whether a valid permit covers work at the jobsite.

According to a second aspect of the invention, a system is provided for controlling a locate operation to locate the presence or absence of underground facilities at a jobsite. The system comprises a processer and a memory, the memory containing modules for execution by the processor, including a receiving module configured to receive a work order that describes a locate operation to locate the presence or absence of underground facilities at a jobsite; an access module configured to access a permit database of a permitting entity based on information from the work order; and a verification module to determine from the permit database of the permitting entity, whether a valid permit covers work at the jobsite.

For purposes of the present disclosure, the term “dig area” refers to a specified area of a work site within which there is a plan to disturb the ground (e.g., excavate, dig holes and/or trenches, bore, etc.), and beyond which there is no plan to excavate in the immediate surroundings. Thus, the metes and bounds of a dig area are intended to provide specificity as to where some disturbance to the ground is planned at a given work site. It should be appreciated that a given work site may include multiple dig areas.

The term “facility” refers to one or more lines, cables, fibers, conduits, transmitters, receivers, or other physical objects or structures capable of or used for carrying, transmitting, receiving, storing, and providing utilities, energy, data, substances, and/or services, and/or any combination thereof. The term “underground facility” means any facility beneath the surface of the ground. Examples of facilities include, but are not limited to, oil, gas, water, sewer, power, telephone, data transmission, cable television (TV), and/or internet services.

The term “locate device” refers to any apparatus and/or device for detecting and/or inferring the presence or absence of any facility, including without limitation, any underground facility. In various examples, a locate device may include both a locate transmitter and a locate receiver (which in some instances may also be referred to collectively as a “locate instrument set,” or simply “locate set”).

The term “marking device” refers to any apparatus, mechanism, or other device that employs a marking dispenser for causing a marking material and/or marking object to be dispensed, or any apparatus, mechanism, or other device for electronically indicating (e.g., logging in memory) a location, such as a location of an underground facility. Additionally, the term “marking dispenser” refers to any apparatus, mechanism, or other device for dispensing and/or otherwise using, separately or in combination, a marking material and/or a marking object. An example of a marking dispenser may include, but is not limited to, a pressurized can of marking paint. The term “marking material” means any material, substance, compound, and/or element, used or which may be used separately or in combination to mark, signify, and/or indicate. Examples of marking materials may include, but are not limited to, paint, chalk, dye, and/or iron. The term “marking object” means any object and/or objects used or which may be used separately or in combination to mark, signify, and/or indicate. Examples of marking objects may include, but are not limited to, a flag, a dart, and arrow, and/or an RFID marking ball. It is contemplated that marking material may include marking objects. It is further contemplated that the terms “marking materials” or “marking objects” may be used interchangeably in accordance with the present disclosure.

The term “locate mark” means any mark, sign, and/or object employed to indicate the presence or absence of any underground facility. Examples of locate marks may include, but are not limited to, marks made with marking materials, marking objects, global positioning or other information, and/or any other means. Locate marks may be represented in any form including, without limitation, physical, visible, electronic, and/or any combination thereof

The terms “actuate” or “trigger” (verb form) are used interchangeably to refer to starting or causing any device, program, system, and/or any combination thereof to work, operate, and/or function in response to some type of signal or stimulus. Examples of actuation signals or stimuli may include, but are not limited to, any local or remote, physical, audible, inaudible, visual, non-visual, electronic, mechanical, electromechanical, biomechanical, biosensing or other signal, instruction, or event. The terms “actuator” or “trigger” (noun form) are used interchangeably to refer to any method or device used to generate one or more signals or stimuli to cause or causing actuation. Examples of an actuator/trigger may include, but are not limited to, any form or combination of a lever, switch, program, processor, screen, microphone for capturing audible commands, and/or other device or method. An actuator/trigger may also include, but is not limited to, a device, software, or program that responds to any movement and/or condition of a user, such as, but not limited to, eye movement, brain activity, heart rate, other data, and/or the like, and generates one or more signals or stimuli in response thereto. In the case of a marking device or other marking mechanism (e.g., to physically or electronically mark a facility or other feature), actuation may cause marking material to be dispensed, as well as various data relating to the marking operation (e.g., geographic location, time stamps, characteristics of material dispensed, etc.) to be logged in an electronic file stored in memory. In the case of a locate device or other locate mechanism (e.g., to physically locate a facility or other feature), actuation may cause a detected signal strength, signal frequency, depth, or other information relating to the locate operation to be logged in an electronic file stored in memory.

The terms “locate and marking operation,” “locate operation,” and “locate” generally are used interchangeably and refer to any activity to detect, infer, and/or mark the presence or absence of an underground facility. In some contexts, the term “locate operation” is used to more specifically refer to detection of one or more underground facilities, and the term “marking operation” is used to more specifically refer to using a marking material and/or one or more marking objects to mark a presence or an absence of one or more underground facilities. The term “locate technician” refers to an individual performing a locate operation. A locate and marking operation often is specified in connection with a dig area, at least a portion of which may be excavated or otherwise disturbed during excavation activities.

The term “user” refers to an individual utilizing a locate device and/or a marking device and may include, but is not limited to, land surveyors, locate technicians, and support personnel.

The terms “locate request” and “excavation notice” are used interchangeably to refer to any communication to request a locate and marking operation. The term “locate request ticket” (or simply “ticket”) refers to any communication or instruction to perform a locate operation. A ticket might specify, for example, the address or description of a dig area to be marked, the day and/or time that the dig area is to be marked, and/or whether the user is to mark the excavation area for certain gas, water, sewer, power, telephone, cable television, and/or some other underground facility. The term “historical ticket” refers to past tickets that have been completed.

The following U.S. published applications are hereby incorporated herein by reference:

U.S. Pat. No. 7,640,105, issued Dec. 29, 2009, filed Mar. 13, 2007, and entitled “Marking System and Method With Location and/or Time Tracking;”

U.S. publication no. 2010-0094553-A1, published Apr. 15, 2010, filed Dec. 16, 2009, and entitled “Systems and Methods for Using Location Data and/or Time Data to Electronically Display Dispensing of Markers by A Marking System or Marking Tool;”

U.S. publication no. 2008-0245299-A1, published Oct. 9, 2008, filed Apr. 4, 2007, and entitled “Marking System and Method;”

U.S. publication no. 2009-0013928-A1, published Jan. 15, 2009, filed Sep. 24, 2008, and entitled “Marking System and Method;”

U.S. publication no. 2010-0090858-A1, published Apr. 15, 2010, filed Dec. 16, 2009, and entitled “Systems and Methods for Using Marking Information to Electronically Display Dispensing of Markers by a Marking System or Marking Tool;”

U.S. publication no. 2009-0238414-A1, published Sep. 24, 2009, filed Mar. 18, 2008, and entitled “Virtual White Lines for Delimiting Planned Excavation Sites;”

U.S. publication no. 2009-0241045-A1, published Sep. 24, 2009, filed Sep. 26, 2008, and entitled “Virtual White Lines for Delimiting Planned Excavation Sites;”

U.S. publication no. 2009-0238415-A1, published Sep. 24, 2009, filed Sep. 26, 2008, and entitled “Virtual White Lines for Delimiting Planned Excavation Sites;”

U.S. publication no. 2009-0241046-A1, published Sep. 24, 2009, filed Jan. 16, 2009, and entitled “Virtual White Lines for Delimiting Planned Excavation Sites;”

U.S. publication no. 2009-0238416-A1, published Sep. 24, 2009, filed Jan. 16, 2009, and entitled “Virtual White Lines for Delimiting Planned Excavation Sites;”

U.S. publication no. 2009-0237408-A1, published Sep. 24, 2009, filed Jan. 16, 2009, and entitled “Virtual White Lines for Delimiting Planned Excavation Sites;”

U.S. publication no. 2011-0135163-A1, published Jun. 9, 2011, filed Feb. 16, 2011, and entitled “Methods and Apparatus for Providing Unbuffered Dig Area Indicators on Aerial Images to Delimit Planned Excavation Sites;”

U.S. publication no. 2009-0202101-A1, published Aug. 13, 2009, filed Feb. 12, 2008, and entitled “Electronic Manifest of Underground Facility Locate Marks;”

U.S. publication no. 2009-0202110-A1, published Aug. 13, 2009, filed Sep. 11, 2008, and entitled “Electronic Manifest of Underground Facility Locate Marks;”

U.S. publication no. 2009-0201311-A1, published Aug. 13, 2009, filed Jan. 30, 2009, and entitled “Electronic Manifest of Underground Facility Locate Marks;”

U.S. publication no. 2009-0202111-A1, published Aug. 13, 2009, filed Jan. 30, 2009, and entitled “Electronic Manifest of Underground Facility Locate Marks;”

U.S. publication no. 2009-0204625-A1, published Aug. 13, 2009, filed Feb. 5, 2009, and entitled “Electronic Manifest of Underground Facility Locate Operation;”

U.S. publication no. 2009-0204466-A1, published Aug. 13, 2009, filed Sep. 4, 2008, and entitled “Ticket Approval System For and Method of Performing Quality Control In Field Service Applications;”

U.S. publication no. 2009-0207019-A1, published Aug. 20, 2009, filed Apr. 30, 2009, and entitled “Ticket Approval System For and Method of Performing Quality Control In Field Service Applications;”

U.S. publication no. 2009-0210284-A1, published Aug. 20, 2009, filed Apr. 30, 2009, and entitled “Ticket Approval System For and Method of Performing Quality Control In Field Service Applications;”

U.S. publication no. 2009-0210297-A1, published Aug. 20, 2009, filed Apr. 30, 2009, and entitled “Ticket Approval System For and Method of Performing Quality Control In Field Service Applications;”

U.S. publication no. 2009-0210298-A1, published Aug. 20, 2009, filed Apr. 30, 2009, and entitled “Ticket Approval System For and Method of Performing Quality Control In Field Service Applications;”

U.S. publication no. 2009-0210285-A1, published Aug. 20, 2009, filed Apr. 30, 2009, and entitled “Ticket Approval System For and Method of Performing Quality Control In Field Service Applications;”

U.S. publication no. 2009-0324815-A1, published Dec. 31, 2009, filed Apr. 24, 2009, and entitled “Marking Apparatus and Marking Methods Using Marking Dispenser with Machine-Readable ID Mechanism;”

U.S. publication no. 2010-0006667-A1, published Jan. 14, 2010, filed Apr. 24, 2009, and entitled, “Marker Detection Mechanisms for use in Marking Devices And Methods of Using Same;”

U.S. publication no. 2010-0085694 A1, published Apr. 8, 2010, filed Sep. 30, 2009, and entitled, “Marking Device Docking Stations and Methods of Using Same;”

U.S. publication no. 2010-0085701 A1, published Apr. 8, 2010, filed Sep. 30, 2009, and entitled, “Marking Device Docking Stations Having Security Features and Methods of Using Same;”

U.S. publication no. 2010-0084532 A1, published Apr. 8, 2010, filed Sep. 30, 2009, and entitled, “Marking Device Docking Stations Having Mechanical Docking and Methods of Using Same;”

U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same;”

U.S. publication no. 2010-0117654 A1, published May 13, 2010, filed Dec. 30, 2009, and entitled, “Methods and Apparatus for Displaying an Electronic Rendering of a Locate and/or Marking Operation Using Display Layers;”

U.S. publication no. 2010-0086677 A1, published Apr. 8, 2010, filed Aug. 11, 2009, and entitled, “Methods and Apparatus for Generating an Electronic Record of a Marking Operation Including Service-Related Information and Ticket Information;”

U.S. publication no. 2010-0086671 A1, published Apr. 8, 2010, filed Nov. 20, 2009, and entitled, “Methods and Apparatus for Generating an Electronic Record of A Marking Operation Including Service-Related Information and Ticket Information;”

U.S. publication no. 2010-0085376 A1, published Apr. 8, 2010, filed Oct. 28, 2009, and entitled, “Methods and Apparatus for Displaying an Electronic Rendering of a Marking Operation Based on an Electronic Record of Marking Information;”

U.S. publication no. 2010-0088164-A1, published Apr. 8, 2010, filed Sep. 30, 2009, and entitled, “Methods and Apparatus for Analyzing Locate and Marking Operations with Respect to Facilities Maps;”

U.S. publication no. 2010-0088134 A1, published Apr. 8, 2010, filed Oct. 1, 2009, and entitled, “Methods and Apparatus for Analyzing Locate and Marking Operations with Respect to Historical Information;”

U.S. publication no. 2010-0088031 A1, published Apr. 8, 2010, filed Sep. 28, 2009, and entitled, “Methods and Apparatus for Generating an Electronic Record of Environmental Landmarks Based on Marking Device Actuations;”

U.S. publication no. 2010-0188407 A1, published Jul. 29, 2010, filed Feb. 5, 2010, and entitled “Methods and Apparatus for Displaying and Processing Facilities Map Information and/or Other Image Information on a Marking Device;”

U.S. publication no. 2010-0198663 A1, published Aug. 5, 2010, filed Feb. 5, 2010, and entitled “Methods and Apparatus for Overlaying Electronic Marking Information on Facilities Map Information and/or Other Image Information Displayed on a Marking Device;”

U.S. publication no. 2010-0188215 A1, published Jul. 29, 2010, filed Feb. 5, 2010, and entitled “Methods and Apparatus for Generating Alerts on a Marking Device, Based on Comparing Electronic Marking Information to Facilities Map Information and/or Other Image Information;”

U.S. publication no. 2010-0188088 A1, published Jul. 29, 2010, filed Feb. 5, 2010, and entitled “Methods and Apparatus for Displaying and Processing Facilities Map Information and/or Other Image Information on a Locate Device;”

U.S. publication no. 2010-0189312 A1, published Jul. 29, 2010, filed Feb. 5, 2010, and entitled “Methods and Apparatus for Overlaying Electronic Locate Information on Facilities Map Information and/or Other Image Information Displayed on a Locate Device;”

U.S. publication no. 2010-0188216 A1, published Jul. 29, 2010, filed Feb. 5, 2010, and entitled “Methods and Apparatus for Generating Alerts on a Locate Device, Based ON Comparing Electronic Locate Information TO Facilities Map Information and/or Other Image Information;”

U.S. publication no. 2010-0189887 A1, published Jul. 29, 2010, filed Feb. 11, 2010, and entitled “Marking Apparatus Having Enhanced Features for Underground Facility Marking Operations, and Associated Methods and Systems;”

U.S. publication no. 2010-0256825-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0255182-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0245086-A1, published Sep. 30, 2010, filed Jun. 9, 2010, and entitled “Marking Apparatus Configured To Detect Out-Of-Tolerance Conditions In Connection With Underground Facility Marking Operations, And Associated Methods And Systems;”

U.S. publication no. 2010-0247754-A1, published Sep. 30, 2010, filed Jun. 9, 2010, and entitled “Methods and Apparatus For Dispensing Marking Material In Connection With Underground Facility Marking Operations Based on Environmental Information and/or Operational Information;”

U.S. publication no. 2010-0262470-A1, published Oct. 14, 2010, filed Jun. 9, 2010, and entitled “Methods, Apparatus, and Systems For Analyzing Use of a Marking Device By a Technician To Perform An Underground Facility Marking Operation;”

U.S. publication no. 2010-0263591-A1, published Oct. 21, 2010, filed Jun. 9, 2010, and entitled “Marking Apparatus Having Environmental Sensors and Operations Sensors for Underground Facility Marking Operations, and Associated Methods and Systems;”

U.S. publication no. 2010-0188245 A1, published Jul. 29, 2010, filed Feb. 11, 2010, and entitled “Locate Apparatus Having Enhanced Features for Underground Facility Locate Operations, and Associated Methods and Systems;”

U.S. publication no. 2010-0253511-A1, published Oct. 7, 2010, filed Jun. 18, 2010, and entitled “Locate Apparatus Configured to Detect Out-of-Tolerance Conditions in Connection with Underground Facility Locate Operations, and Associated Methods and Systems;”

U.S. publication no. 2010-0257029-A1, published Oct. 7, 2010, filed Jun. 18, 2010, and entitled “Methods, Apparatus, and Systems For Analyzing Use of a Locate Device By a Technician to Perform an Underground Facility Locate Operation;”

U.S. publication no. 2010-0253513-A1, published Oct. 7, 2010, filed Jun. 18, 2010, and entitled “Locate Transmitter Having Enhanced Features For Underground Facility Locate Operations, and Associated Methods and Systems;”

U.S. publication no. 2010-0253514-A1, published Oct. 7, 2010, filed Jun. 18, 2010, and entitled “Locate Transmitter Configured to Detect Out-of-Tolerance Conditions In Connection With Underground Facility Locate Operations, and Associated Methods and Systems;”

U.S. publication no. 2010-0256912-A1, published Oct. 7, 2010, filed Jun. 18, 2010, and entitled “Locate Apparatus for Receiving Environmental Information Regarding Underground Facility Marking Operations, and Associated Methods and Systems;”

U.S. publication no. 2009-0204238-A1, published Aug. 13, 2009, filed Feb. 2, 2009, and entitled “Electronically Controlled Marking Apparatus and Methods;”

U.S. publication no. 2009-0208642-A1, published Aug. 20, 2009, filed Feb. 2, 2009, and entitled “Marking Apparatus and Methods For Creating an Electronic Record of Marking Operations;”

U.S. publication no. 2009-0210098-A1, published Aug. 20, 2009, filed Feb. 2, 2009, and entitled “Marking Apparatus and Methods For Creating an Electronic Record of Marking Apparatus Operations;”

U.S. publication no. 2009-0201178-A1, published Aug. 13, 2009, filed Feb. 2, 2009, and entitled “Methods For Evaluating Operation of Marking Apparatus;”

U.S. publication no. 2009-0238417-A1, published Sep. 24, 2009, filed Feb. 6, 2009, and entitled “Virtual White Lines for Indicating Planned Excavation Sites on Electronic Images;”

U.S. publication no. 2010-0205264-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0205031-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0259381-A1, published Oct. 14, 2010, filed Jun. 28, 2010, and entitled “Methods, Apparatus and Systems for Notifying Excavators and Other Entities of the Status of in-Progress Underground Facility Locate and Marking Operations;”

U.S. publication no. 2010-0262670-A1, published Oct. 14, 2010, filed Jun. 28, 2010, and entitled “Methods, Apparatus and Systems for Communicating Information Relating to the Performance of Underground Facility Locate and Marking Operations to Excavators and Other Entities;”

U.S. publication no. 2010-0259414-A1, published Oct. 14, 2010, filed Jun. 28, 2010, and entitled “Methods, Apparatus And Systems For Submitting Virtual White Line Drawings And Managing Notifications In Connection With Underground Facility Locate And Marking Operations;”

U.S. publication no. 2010-0268786-A1, published Oct. 21, 2010, filed Jun. 28, 2010, and entitled “Methods, Apparatus and Systems for Requesting Underground Facility Locate and Marking Operations and Managing Associated Notifications;”

U.S. publication no. 2010-0201706-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205555-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205195-A1, published Aug. 12, 2010, filed Jun. 1, 2009, and entitled “Methods and Apparatus for Associating a Virtual White Line (VWL) Image with Corresponding Ticket Information for an Excavation Project;”

U.S. publication no. 2010-0205536-A1, published Aug. 12, 2010, filed Jun. 1, 2009, and entitled “Methods and Apparatus for Controlling Access to a Virtual White Line (VWL) Image for an Excavation Project;”

U.S. publication no. 2010-0228588-A1, published Sep. 9, 2010, filed Feb. 11, 2010, and entitled “Management System, and Associated Methods and Apparatus, for Providing Improved Visibility, Quality Control and Audit Capability for Underground Facility Locate and/or Marking Operations;”

U.S. publication no. 2010-0324967-A1, published Dec. 23, 2010, filed Jul. 9, 2010, and entitled “Management System, and Associated Methods and Apparatus, for Dispatching Tickets, Receiving Field Information, and Performing A Quality Assessment for Underground Facility Locate and/or Marking Operations;”

U.S. publication no. 2010-0318401-A1, published Dec. 16, 2010, filed Jul. 9, 2010, and entitled “Methods and Apparatus for Performing Locate and/or Marking Operations with Improved Visibility, Quality Control and Audit Capability;”

U.S. publication no. 2010-0318402-A1, published Dec. 16, 2010, filed Jul. 9, 2010, and entitled “Methods and Apparatus for Managing Locate and/or Marking Operations;”

U.S. pyublication no. 2010-0318465-A1, published Dec. 16, 2010, filed Jul. 9, 2010, and entitled “Systems and Methods for Managing Access to Information Relating to Locate and/or Marking Operations;”

U.S. publication no. 2010-0201690-A1, published Aug. 12, 2010, filed Apr. 13, 2009, and entitled “Virtual White Lines (VWL) Application for Indicating a Planned Excavation or Locate Path;”

U.S. publication no. 2010-0205554-A1, published Aug. 12, 2010, filed Apr. 13, 2009, and entitled “Virtual White Lines (VWL) Application for Indicating an Area of Planned Excavation;”

U.S. publication no. 2009-0202112-A1, published Aug. 13, 2009, filed Feb. 11, 2009, and entitled “Searchable Electronic Records of Underground Facility Locate Marking Operations;”

U.S. publication no. 2009-0204614-A1, published Aug. 13, 2009, filed Feb. 11, 2009, and entitled “Searchable Electronic Records of Underground Facility Locate Marking Operations;”

U.S. publication no. 2011-0060496-A1, published Mar. 10, 2011, filed Aug. 10, 2010, and entitled “Systems and Methods for Complex Event Processing of Vehicle Information and Image Information Relating to a Vehicle;”

U.S. publication no. 2011-0093162-A1, published Apr. 21, 2011, filed Dec. 28, 2010, and entitled “Systems And Methods For Complex Event Processing Of Vehicle-Related Information;”

U.S. publication no. 2011-0093306-A1, published Apr. 21, 2011, filed Dec. 28, 2010, and entitled “Fleet Management Systems And Methods For Complex Event Processing Of Vehicle-Related Information Via Local And Remote Complex Event Processing Engines;”

U.S. publication no. 2011-0093304-A1, published Apr. 21, 2011, filed Dec. 29, 2010, and entitled “Systems And Methods For Complex Event Processing Based On A Hierarchical Arrangement Of Complex Event Processing Engines;”

U.S. publication no. 2010-0257477-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0256981-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0205032-A1, published Aug. 12, 2010, filed Feb. 11, 2010, and entitled “Marking Apparatus Equipped with Ticket Processing Software for Facilitating Marking Operations, and Associated Methods;”

U.S. publication no. 2011-0035251-A1, published Feb. 10, 2011, filed Jul. 15, 2010, and entitled “Methods, Apparatus, and Systems for Facilitating and/or Verifying Locate and/or Marking Operations;”

U.S. publication no. 2011-0035328-A1, published Feb. 10, 2011, filed Jul. 15, 2010, and entitled “Methods, Apparatus, and Systems for Generating Technician Checklists for Locate and/or Marking Operations;”

U.S. publication no. 2011-0035252-A1, published Feb. 10, 2011, filed Jul. 15, 2010, and entitled “Methods, Apparatus, and Systems for Processing Technician Checklists for Locate and/or Marking Operations;”

U.S. publication no. 2011-0035324-A1, published Feb. 10, 2011, filed Jul. 15, 2010, and entitled “Methods, Apparatus, and Systems for Generating Technician Workflows for Locate and/or Marking Operations;”

U.S. publication no. 2011-0035245-A1, published Feb. 10, 2011, filed Jul. 15, 2010, and entitled “Methods, Apparatus, and Systems for Processing Technician Workflows for Locate and/or Marking Operations;”

U.S. publication no. 2011-0035260-A1, published Feb. 10, 2011, filed Jul. 15, 2010, and entitled “Methods, Apparatus, and Systems for Quality Assessment of Locate and/or Marking Operations Based on Process Guides;”

U.S. publication no. 2010-0256863-A1, published Oct. 7, 2010, filed Apr. 2, 2010, and entitled “Methods, Apparatus, and Systems for Acquiring and Analyzing Vehicle Data and Generating an Electronic Representation of Vehicle Operations;”

U.S. publication no. 2011-0022433-A1, published Jan. 27, 2011, filed Jun. 24, 2010, and entitled “Methods and Apparatus for Assessing Locate Request Tickets;”

U.S. publication no. 2011-0040589-A1, published Feb. 17, 2011, filed Jul. 21, 2010, and entitled “Methods and Apparatus for Assessing Complexity of Locate Request Tickets;”

U.S. publication no. 2011-0046993-A1, published Feb. 24, 2011, filed Jul. 21, 2010, and entitled “Methods and Apparatus for Assessing Risks Associated with Locate Request Tickets;”

U.S. publication no. 2011-0046994-A1, published Feb. 17, 2011, filed Jul. 21, 2010, and entitled “Methods and Apparatus for Multi-Stage Assessment of Locate Request Tickets;”

U.S. publication no. 2011-0040590-A1, published Feb. 17, 2011, filed Jul. 21, 2010, and entitled “Methods and Apparatus for Improving a Ticket Assessment System;”

U.S. publication no. 2011-0020776-A1, published Jan. 27, 2011, filed Jun. 25, 2010, and entitled “Locating Equipment for and Methods of Simulating Locate Operations for Training and/or Skills Evaluation;”

U.S. publication no. 2010-0285211-A1, published Nov. 11, 2010, filed Apr. 21, 2010, and entitled “Method Of Using Coded Marking Patterns In Underground Facilities Locate Operations;”

U.S. publication no. 2011-0137769-A1, published Jun. 9, 2011, filed Nov. 5, 2010, and entitled “Method Of Using Coded Marking Patterns In Underground Facilities Locate Operations;”

U.S. publication no. 2009-0327024-A1, published Dec. 31, 2009, filed Jun. 26, 2009, and entitled “Methods and Apparatus for Quality Assessment of a Field Service Operation;”

U.S. publication no. 2010-0010862-A1, published Jan. 14, 2010, filed Aug. 7, 2009, and entitled, “Methods and Apparatus for Quality Assessment of a Field Service Operation Based on Geographic Information;”

U.S. publication No. 2010-0010863-A1, published Jan. 14, 2010, filed Aug. 7, 2009, and entitled, “Methods and Apparatus for Quality Assessment of a Field Service Operation Based on Multiple Scoring Categories;”

U.S. publication no. 2010-0010882-A1, published Jan. 14, 2010, filed Aug. 7, 2009, and entitled, “Methods and Apparatus for Quality Assessment of a Field Service Operation Based on Dynamic Assessment Parameters;”

U.S. publication no. 2010-0010883-A1, published Jan. 14, 2010, filed Aug. 7, 2009, and entitled, “Methods and Apparatus for Quality Assessment of a Field Service Operation Based on Multiple Quality Assessment Criteria;”

U.S. publication no. 2011-0007076-A1, published Jan. 13, 2011, filed Jul. 7, 2010, and entitled, “Methods, Apparatus and Systems for Generating Searchable Electronic Records of Underground Facility Locate and/or Marking Operations;”

U.S. publication no. 2011-0131081-A1, published Jun. 2, 2011, filed Oct. 29, 2010, and entitled “Methods, Apparatus, and Systems for Providing an Enhanced Positive Response in Underground Facility Locate and Marking Operations;”

U.S. publication no. 2011-0060549-A1, published Mar. 10, 2011, filed Aug. 13, 2010, and entitled, “Methods and Apparatus for Assessing Marking Operations Based on Acceleration Information;”

U.S. publication no. 2011-0117272-A1, published May 19, 2011, filed Aug. 19, 2010, and entitled, “Marking Device with Transmitter for Triangulating Location During Locate Operations;”

U.S. publication no. 2011-0045175-A1, published Feb. 24, 2011, filed May 25, 2010, and entitled, “Methods and Marking Devices with Mechanisms for Indicating and/or Detecting Marking Material Color;”

U.S. publication no. 2010-0088135 A1, published Apr. 8, 2010, filed Oct. 1, 2009, and entitled, “Methods and Apparatus for Analyzing Locate and Marking Operations with Respect to Environmental Landmarks;”

U.S. publication no. 2010-0085185 A1, published Apr. 8, 2010, filed Sep. 30, 2009, and entitled, “Methods and Apparatus for Generating Electronic Records of Locate Operations;”

U.S. publication no. 2011-0095885 A9 (Corrected Publication), published Apr. 28, 2011, and entitled, “Methods And Apparatus For Generating Electronic Records Of Locate Operations;”

U.S. publication no. 2010-0090700-A1, published Apr. 15, 2010, filed Oct. 30, 2009, and entitled “Methods and Apparatus for Displaying an Electronic Rendering of a Locate Operation Based on an Electronic Record of Locate Information;”

U.S. publication no. 2010-0085054 A1, published Apr. 8, 2010, filed Sep. 30, 2009, and entitled, “Systems and Methods for Generating Electronic Records of Locate And Marking Operations;” and

U.S. publication no. 2011-0046999-A1, published Feb. 24, 2011, filed Aug. 4, 2010, and entitled, “Methods and Apparatus for Analyzing Locate and Marking Operations by Comparing Locate Information and Marking Information.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF DRAWINGS

The present invention, both as to its organization and manner of operation, together with further objectives and advantages, may be best understood by reference to the following description, taken in connection with the accompanying drawings as set forth below:

FIG. 1 is a functional block diagram of an example of an excavator notification system for confirming locate operation work orders with respect to municipal permits, according to embodiments of the invention; and

FIG. 2 is a flow diagram of an example of a method of confirming locate operation work orders with respect to municipal permits, according to embodiments of the invention.

### DETAILED DESCRIPTION

Various embodiments of the present invention relate generally to systems for and methods of confirming locate operation work orders with respect to municipal permits. For example, an excavator notification system according to the present invention provides mechanisms for using locate operation work order information to access a database including relevant electronic records of municipal permits in order to (1) determine the status (i.e., existence of or absence of) a municipal permit for a locate operation work order, (2) determine whether the information of the locate operation work order is in compliance with the information of its corresponding municipal permit, and/or (3) provide municipal permit status information to interested parties, such as to regulators, facility owners, the locate company, the one-call center from which the locate operation work order originated, and/or the excavator from which the locate operation work order originated.

The excavator notification system and methods of the present invention allow, for example, locate companies to confirm in advance of performing locate operations whether a valid municipal permit exists for the jobsite that is the subject of the locate operation work order. When the existence of the valid municipal permit is confirmed, this information may be transmitted to the originating parties, and locate operations and/or excavation operations may be performed. When the existence of the valid municipal permit is not confirmed, the work associated with the locate operation work order may still be performed in some embodiments. However, an alert may be transmitted to the originating parties that a valid municipal permit is not confirmed. Further, the alert status may be logged in the electronic record of the locate operation. In other embodiments, the work associated with the locate operation work order may be delayed or otherwise not performed when a valid municipal permit is not found.

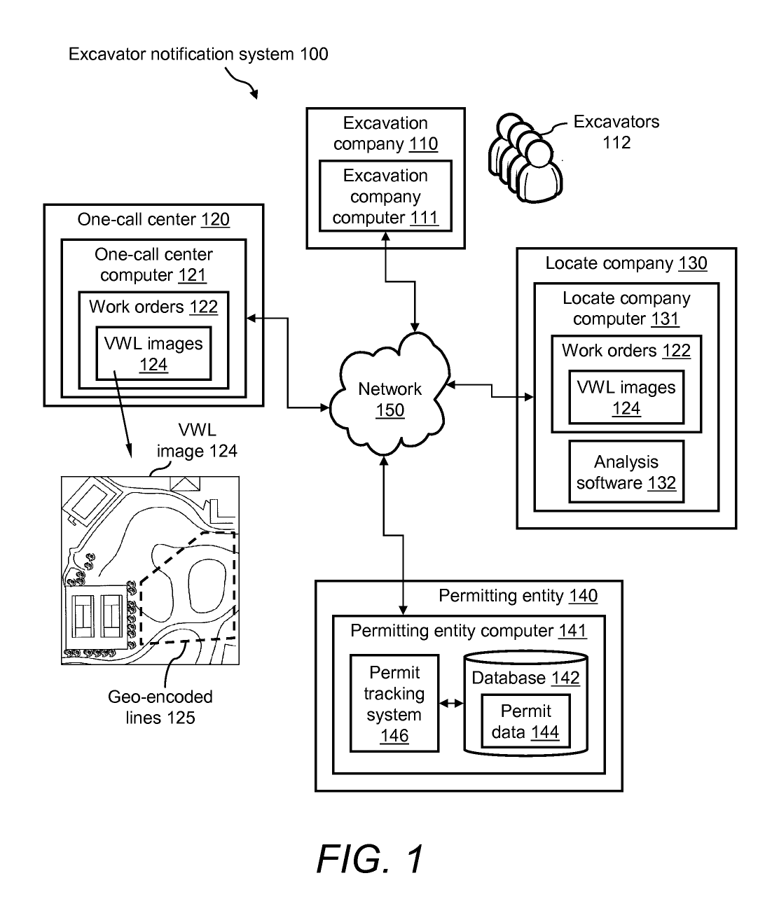

FIG. 1 is a functional block diagram of an example of an excavator notification system 100 for confirming locate operation work orders with respect to municipal permits. Excavator notification system 100 may include an excavation company 110 and associated excavators 112, a one-call center 120, a locate company 130, and a permitting entity 140. A network 150 provides a wired and/or wireless communication network by which information may be exchanged between excavation company 110, one-call center 120, locate company 130, and permitting entity 140. For example, network 150 may be a local area network (LAN) and/or wide area network (WAN) for connecting to the Internet. It will be understood that excavator notification system 100 may include one or more excavation companies 110, one or more one-call centers 120, one or more locate companies 130, and one or more permitting entities 140.

Excavation companies 110 may provide excavation services, such as, but not limited to, excavation services related to the construction industry and excavation services related to the installation and/or maintenance of underground facilities. Each excavation company 110 includes an excavation company computer 111 that may communicate with other entities of the excavator notification system 100 via network 150. Associated with excavation companies 110 are one or more excavators 112. Excavators 112 may be individuals who are requesting and/or performing the excavation operations. In particular, excavators 112 generate work orders 122, which are requests for locate services. Work orders 122 may be processed by one-call centers 120. Work orders 122 may be a communication or instruction to perform a locate operation at a dig area, which is a specified geographic area within which excavation may occur.

Additionally, work orders 122 may include one or more virtual white lines (VWL) images 124 attached thereto. Each VWL image 124 is, for example, a digital aerial image of the dig area that has been electronically marked up for indicating an area, point, line, and/or path of planned excavation. The markings of each VWL image 124 are geo-referenced. FIG. 1 shows an example of a VWL image 124, which is an aerial image that has been electronically marked up with geo-encoded lines 125 to indicate an area, point, line, and/or path of planned excavation.

VWL images 124 are created by excavators 112 using a computer software application (not shown). For example, the computer software application for creating VWL images 124 may be based on the VWL application described in U.S. Patent Publication No. 2009/0238417, entitled “Virtual White Lines for Indicating Planned Excavation Sites on Electronic Images;” and U.S. Patent Publication No. 2009/0238414, entitled “Virtual White Lines for Delimiting Planned Excavation Sites”, which are incorporated herein by reference in their entirety.

One-call centers 120 may be organizations, entities, and/or systems that receive, process, and/or transmit work orders 122. One-call centers are generally owned, controlled, or funded by underground facility owners, such as telephone companies, cable television multiple system operators, electric utilities, gas utilities, or others. One-call center operations may be managed by a non-profit entity or outsourced to a for-profit firm. As shown in FIG. 1, one-call center 120 includes a one-call center computer 121 that may receive, process, and/or transmit work orders 122. Each work order 122 may include one or more VWL images 124 attached thereto. Excavators, such as excavators 112, are required to notify one-call centers in advance of their excavation activities and to identify through a work order 122 the dig area where individual excavating activities will be performed. Work orders 122 consist of information supplied by the excavator to the one-call center regarding the specific geographic location of the dig area, date, time, purpose of excavation, and so on. Each work order 122, in turn, requires activity from an underground facility owner to perform a locate operation in the specified dig area.

Locate companies 130 may be companies that provide locate services with respect, for example, to underground facilities. Certain locate personnel, such as locate technicians (not shown) that perform locate operations, may be associated with locate companies 130. As shown in FIG. 1, locate company 130 may include a locate company computer 131. Locate company computer 131 may include one or more work orders 122 and analysis software 132 as described herein.

Additionally, permitting entities 140 may be included in the aforementioned communication process, according to embodiments of the invention. Permitting entities 140 may be local (e.g., towns, cities), county, state, regional, and/or federal entities that are the governing bodies that issue permits. Each permitting entity 140 may include, for example, a permitting entity computer 141. The permitting entity computer may include a permit database 142 in which is stored permit data 144. Permit data 144 contains electronic records of, for example, granted and pending permits. Examples of types of municipal permits may include, but are not limited to, building permits, excavation permits, land use permits, and the like. Each record (i.e., each individual permit) of permit data 144 may include, for example, the dates between which the permit is valid, location of the planned work (e.g., address information), detailed information (i.e., textual descriptions, drawings) about the planned work that is the subject of the permit, type of work to be done, and the like. Additionally, permit data 144 may be extended to include information about applicable ordinances. For example, there may be an ordinance that prohibits dispensing marking material on sidewalks in a specified neighborhood.

Permitting entity computer 141 may also include a permit tracking system 146 for managing permit data 144 at database 142. Permit tracking system 146 may be an electronic permit tracking system that is accessible via network 150. For example, permit tracking system 146 may provide a web-based portal by which authorized users may query permit information, such as permit information stored in permit data 144. Examples of authorized users of permit tracking system 146 may include excavation companies 110, one-call centers 120, and locate companies 130. One example of a web-based permit tracking portal is the portal operated by Palm Beach County, Fla. Another example of a web-based permit tracking portal is the portal operated by the City of Atlanta, Ga. The web-based query may be, for example, by permit type, permit number, permit date, permit address, the name of the individual or entity to which the permit is granted, and the like.

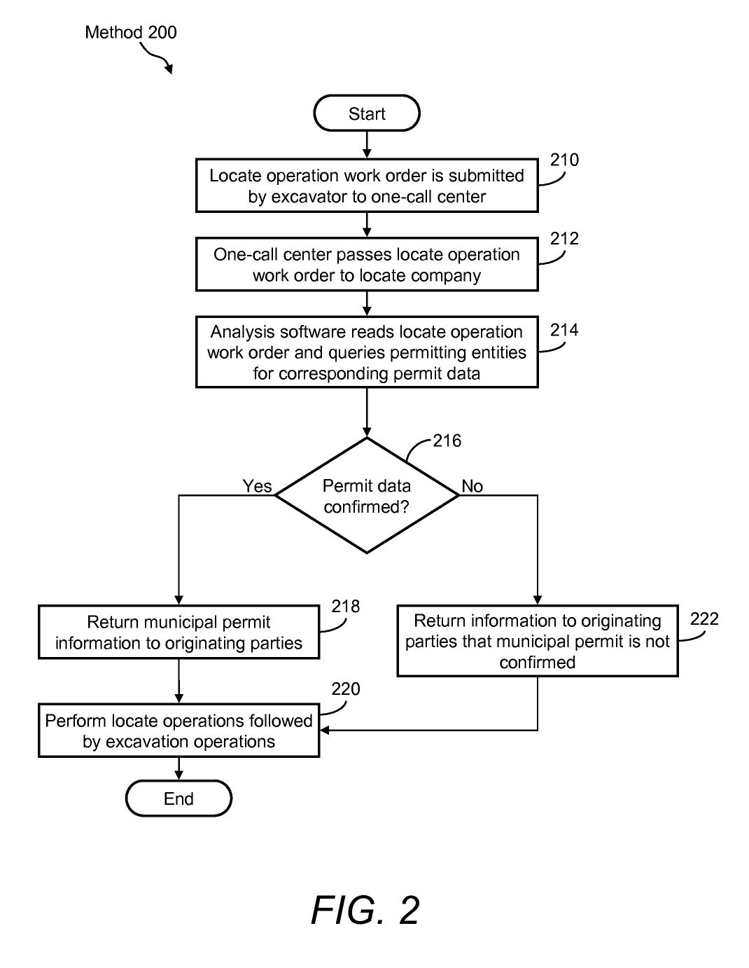

The operation of excavator notification system 100 for confirming locate operation work orders with respect to municipal permits may be summarized as follows. An excavator 112 of an excavation company 110 submits a work order 122 to a one-call center 120 via excavation company computer 111. The work order 122 indicates the planned excavation. Along with the work order 122, the excavator 112 may submit a VWL image 124. The work order 122 with its corresponding VWL image 124 is passed from the one-call center computer 121 to locate company computer 131. Before the work order 122 is assigned to a locate technician for dispatch to the jobsite, information from the work order 122 and of the VWL image 124 is used to access relevant permit data 144 of a permitting entity 140. For example, analysis software 132 may reside, for example, at locate company computer 131. Analysis software 132 is capable of analyzing the contents of textual information as well as analyzing the geo-referenced markups (e.g., geo-encoded lines 125) from VWL images 124. This analysis software 132 may use the information from work order 122 and VWL image 124 to access relevant permit data 144 to determine and report the status (i.e., existence of or absence of) a municipal permit. Further, the geo-location of the approximate center of the markings drawn on VWL images 124 may be extracted. This geo-location may be used as a reference geo-location from which one or more addresses may be returned that are in close proximity to this geo-location. Analysis software 132 may then query for permit information with respect to these one or more addresses. Details of examples of methods of confirming locate operation work orders with respect to municipal permits are described with reference to FIG. 2.

The permit information may be maintained by permitting entity 140 in permit database 142. In some cases, the permit database 142 may include an index to assist in accessing specific permit information. Alternatively, or in addition to the index, the permit database 142 may include one or more searchable fields to facilitate access. Such searchable fields may include, but are not limited to, the address to which the permit applies, a permit identifier, a job identifier and/or a property identifier. Analysis software 132 may extract the relevant parameter from work order 122 and query the permit database 142 to access the applicable permit. The analysis software 132 may extract information of interest from the applicable permit or may download the permit and, for example, generate a display of the applicable permit.

FIG. 2 is a flow diagram of a method 200 of confirming locate operation work orders with respect to municipal permits by use of excavator notification system 100, according to embodiments of the invention. Method 200 may include, but is not limited to, the following acts, which may be implemented in a different order.

In act 210, a locate operation work order is submitted by the excavator to the one-call center. For example, a work order 122 that may also include a VWL image 124 is submitted by excavator 112 to one-call center 120. The work order 122 indicates planned excavation and a request for locate services.

In act 212, the one-call center passes the locate operation work order to the locate company. For example, the one-call center 120 passes the work order 122 submitted in act 210 to locate company 130.

In act 214, analysis software reads the locate operation work order and queries the permitting entities for corresponding permit data. For example, analysis software 132 at the receiving locate company computer 131 reads, for example, location information (e.g., address information) and date information of the work order 122 and queries database 142 of permitting entity 140 for permit data 144 that corresponds to the location information (e.g., address information) and date information of the work order 122. In one example, the address of the planned excavation (as indicated on work order 122) is 5283 Westminster Terrace, Oviedo, Fla. and the date of planned excavation is Jan. 27, 2010. In this example, analysis software 132 queries permit data 144 for a municipal permit that matches the address (i.e., 5283 Westminster Terrace, Oviedo, Fla.) and is valid for the date of work order 122 (i.e., Jan. 27, 2010).

In act 216, it is determined whether the permit data is confirmed. For example, if analysis software 132 confirms that a municipal permit exists in permit data 144 that matches the location and date information of the work order 122, method 200 may proceed, for example, to act 218. However, if analysis software 132 finds no municipal permit in permit data 144 that matches the location and date information of the work order 122, method 200 may proceed, for example, to act 222.

In act 218, confirmation of the municipal permit may be returned to the originating parties. For example, confirmation as well as the electronic municipal permit information that was discovered in permit data 144 in act 214 may be returned to the originating excavation company 110, originating one-call center 120, and/or receiving locate company 130.

In act 220, locate operations may be performed followed by excavation operations. For example, once the originating excavator 112, originating one-call center 120, and/or receiving locate company 130 has received the electronic municipal permit information and manually verifies that the municipal permit is in order, the locate company 130 may proceed with locate operations. Subsequently, the originating excavation company 110 may proceed with excavation operations.

In act 222, an alert or other indication that a municipal permit is not confirmed is returned to the originating parties. For example, an alert that a municipal permit for the location and date indicated on work order 122 does not exist may be returned to the originating excavation company 110, originating one-call center 120, and/or receiving locate company 130. Further, the alert status may be logged in the electronic record of the locate operation. In one embodiment, when the municipal permit is not confirmed, method 200 may proceed, for example, to act 220. In another embodiment, when the municipal permit is not confirmed, the locate operation and/or planned excavation operation may be suspended.

As described above, excavation company computer 111 may be utilized to forward work orders to one-call center computer 121, one-call center computer 121 may be used to forward the work orders to locate company computer 131, and locate company computer 131 may be utilized to query permit database 142 for permit data 144. Each of the computers 111, 121, 131 and 141 may comprise a memory, one or more processing units, one or more communication interfaces, one or more display units, and one or more user input devices. The memory may comprise any non-transitory computer-readable storage media and may store computer instructions for implementing the various applications of the excavator notification system 100. The memory of permitting entity computer 141 also includes permit database 142. The processing unit or units may be used to execute the instructions. The communication interface may be coupled to a wired or wireless network, bus or other communication means and may therefore allow the computer to transmit communications to and/or receive communications from other devices. The display units may be provided, for example, to allow a user to view various information in connection with execution of the instructions. The user input devices may be provided, for example, to allow the user to make manual adjustments, to make selections, to enter data or various other information, and/or interact in any of a variety of manners with the processor during execution of the instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, an intelligent network (IN) or the Internet. Such networks may be based on any suitable technology and may operate according to any suitable protocol and may include wireless networks, wired networks or fiber optic networks.

Any computer discussed herein may comprise a memory, one or more processing units (also referred to herein simply as “processors”), one or more communication interfaces, one or more display units, and one or more user input devices (user interfaces). The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer-implemented method for determining a permit status of a jobsite at which a locate operation is requested and/or performed, the method comprising:
receiving, by a computing device, a work order that describes the locate operation;
accessing, by the computing device, a permit database of a permitting entity based at least in part on information from the work order; and
determining, by the computing device, from the permit database of the permitting entity, whether a valid permit covers work at the jobsite.

2. The method of claim 1, wherein accessing the permit database includes accessing an index of the permit database.

3. The method of claim 1, wherein accessing the permit database includes accessing at least one searchable field of the permit database.

4. The method of claim 1, further comprising accessing information in the valid permit.

5. The method of claim 1, further comprising determining an expiration date of the valid permit.

6. The method of claim 1, further comprising, if a valid permit is not found in the permit database, performing the locate operation and generating an alert indicating that a valid permit was not found in the permit database.

7. The method of claim 1, further comprising, if a valid permit is not found in the permit database, delaying the locate operation and sending an alert indicating that a valid permit was not found in the permit database.

8. The method of claim 1, wherein the permit database is accessed based on an address of the jobsite.

9. The method of claim 1, wherein the permit database is accessed based on geographic coordinates of the jobsite.

10. The method of claim 1, wherein the permit database is accessed based on a permit identifier.

11. The method of claim 1, wherein the permit database is accessed based on a job identifier.

12. The method of claim 1, wherein the permit database is accessed based on a property identifier.

13. The method of claim 1, wherein the permit database is accessed based on information from a virtual white line image included with the work order.

14. The method of claim 1, further comprising displaying, on a display unit of the computing device, the valid permit.

15. A non-transitory computer readable medium encoded with processor-executable instructions that, when executed by at least one processor, perform a method for determining a permit status of a jobsite at which a locate operation is requested and/or performed, the method comprising:
receiving a work order that describes the locate operation;
accessing a permit database of a permitting entity based at least in part on information from the work order; and
determining from the permit database of the permitting entity whether a valid permit covers work at the jobsite.

16. An apparatus for determining a permit status of a jobsite at which a locate operation is requested and/or performed, the apparatus comprising:
a communication interface;
a memory to store processor-executable instructions; and
a processor coupled to the communication interface and the memory, wherein upon execution of the processor-executable instructions by the processor, the processor:
controls the communication interface so as to receive a work order that describes the locate operation;
controls the communication interface so as to access a permit database of a permitting entity based at least in part on information from the work order; and
determines from the permit database of the permitting entity whether a valid permit covers work at the jobsite.

17. The apparatus of claim 16, wherein the processor further determines an expiration date of the valid permit.

18. The apparatus of claim 16, wherein the processor accesses the permit database based on at least one of:
an address of the jobsite;
geographic coordinates of the jobsite;
a permit identifier;
a job identifier; and
a property identifier.

19. The apparatus of claim 16, wherein the processor accesses the permit database based on information from a virtual white line image included with the work order.

20. The apparatus of claim 16, further comprising a display device coupled to the processor to display the valid permit if present in the permit database.
